(19) United States
(12) Patent Application Publication
(10) Pub. No.: US 2008/0172289 A1
(43) Pub. Date: Jul. 17, 2008

(54) Automatic pricing measurement and analysis method and system

(76) Inventors: Eng Oh, Peoria, IL (US); Benjamin H. Hughes, Washington, IL (US); Eric R. Nieukirk, Morton, IL (US); Nathan B. Englehardt, Peoria, IL (US); Sam J. Kieffer, Morton, IL (US); Jerry T. Lefler, Canton, IL (US); Philip K. Brown, Washington, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/003,197

(22) Filed: Dec. 20, 2007

Related U.S. Application Data
(60) Provisional application No. 60/876,503, filed on Dec. 22, 2006.

(51) Int. Cl. G06Q 10/00

(52) U.S. Cl. 705/10; 705/30; 705/7

(57) ABSTRACT

A method is provided for analyzing pricing and revenue information of a product of a business organization having a plurality of data suppliers. The method may include obtaining transaction data associated with the product and obtaining ledger data associated with the product. The method may also include merging the transaction data and the ledger data to generate new data entries and identifying a plurality of revenue breakdown factors corresponding to revenue of the product based on the new data entries. Further, the method may include predicting a new revenue based on the plurality of revenue breakdown factors and a previous revenue from the ledger data.

### CROSS REFERENCE TO RELATED APPLICATIONS

This application is based upon and claims the benefit of priority of U.S. provisional application No. 60/876,503, “Automatic pricing measurement and analysis method and system,” to Eng Oh, filed on Dec. 22, 2006.

### TECHNICAL FIELD

This disclosure relates generally to price and revenue analysis techniques and, more particularly, to methods and systems used for automatically analyzing and forecasting prices and revenues.

### BACKGROUND

Today's business organizations often have a number of business locations and conduct business in many different geographical regions. That may result in a large number of business transactions in various stages of a product, such as purchasing of materials, manufacturing, marketing, and distributing the product, and sale of the product. The complexity and volume of transactions may often make it impractical or impossible for a business organization's management to understand what is actually happening at every transaction level. Management information systems often do not report transaction price performance, or may report only average prices and thus may not illuminate pricing opportunities lost on a transaction-by-transaction basis. Moreover, many companies only report on final invoice price related to the original base price.

Further, because the business organization may sell products through agents, brokers, or other intermediaries, final invoice price may not reflect the true transaction price or revenue associated with the transaction. Additional factors, such as prompt payment discounts, volume buying incentives, commissions and bonuses payable to sales brokers and agents, and cooperative advertising allowances, etc., may vary for different transactions, different brokers, and/or different business units. These factors, even if reported, may be inconsistent with one another and may often be omitted from central management databases.

Technologies such as price models have been developed to manage price modeling data collected in previous transactions. For example, U.S. Patent Application Publication No. 2005/0278227 to Esary et al. published on Dec. 15, 2005, discloses a system for managing price modeling data through closed-loop analytics including a historical database populated with price modeling data; a rule based policy database populated with rules based on historical price modeling data; a transactional database for generating quotes conforming to rules from the rule based policy database; and a service database for transacting quotes generated by the transaction database and providing the transacted quotes to the historical database. However, such conventional techniques often fail to address issues such as pricing measurement with enterprise-wide consistency, price band analysis, and/or identify individual factors for revenue analysis purposes, etc.

Methods and systems consistent with certain features of the disclosed systems are directed to solving one or more of the problems set forth above.

### SUMMARY OF THE INVENTION

One aspect of the present disclosure includes a method for analyzing pricing and revenue information of a product of a business organization having a plurality of data suppliers. The method may include obtaining transaction data associated with the product and obtaining ledger data associated with the product. The method may also include merging the transaction data and the ledger data to generate new data entries and identifying a plurality of revenue breakdown factors corresponding to revenue of the product based on the new data entries. Further, the method may include predicting a new revenue based on the plurality of revenue breakdown factors and a previous revenue from the ledger data.

Another aspect of the present disclosure includes a computer system. The computer system may include a processor and a database. The processor may be configured to obtain transaction data associated with a product of a business organization having a plurality of data suppliers and to obtain ledger data associated with the product. The processor may also be configured to merge the transaction data and the ledger data to generate new data entries and to identify a plurality of revenue breakdown factors corresponding to revenue of the product based on the new data entries. Further, the processor may be configured to predict a new revenue based on the plurality of revenue breakdown factors and a previous revenue from the ledger data. The database may be configured to store the transaction data, the ledger data, and the new data entries.

### BRIEF DESCRIPTION OF THE DRAWINGS

FIG. 1 illustrates a block diagram of an exemplary pricing measurement and analysis environment consistent with certain disclosed embodiments;

FIG. 2 illustrates a block diagram of an exemplary server consistent with certain disclosed embodiments;

FIG. 3 illustrates a flowchart of an exemplary pricing and revenue forecasting process consistent with certain disclosed embodiments;

FIG. 4 illustrates a flowchart of an exemplary revenue breakdown process consistent with certain disclosed embodiments;

FIG. 5 illustrates a diagram of an exemplary waterfall revenue diagram consistent with certain disclosed embodiments;

FIG. 6 illustrates a diagram of an exemplary price band diagram consistent with certain disclosed embodiments; and

FIG. 7 illustrates a flowchart of an exemplary revenue analysis process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

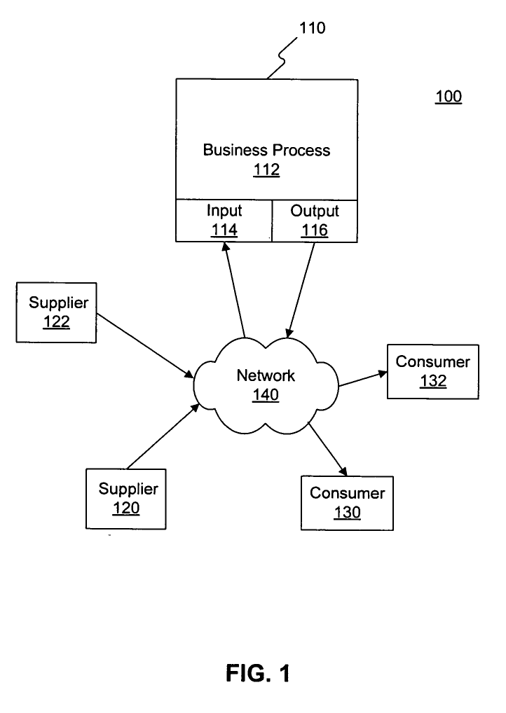

FIG. 1 illustrates a block diagram of an exemplary pricing measurement and analysis environment 100. As shown in FIG. 1, server 110 may include a business process 112 that provides automatic pricing measurement and analysis operation based on an input 114. An output 116 may be generated by business process 112 as a result from the automatic pricing measurement and analysis operation. A supplier 120 and a supplier 122 may, through a network 140, provide data to collectively form input 114. On the other hand, output 116 may, through network 140, be provided to a consumer 130 and a consumer 132 as desired or required pricing data and/or a relative representation of the pricing data. It is understood that the above components or devices are listed for illustrative purposes and not intended to be limiting. The number of the devices may be changed, and other devices may be added without departing from the principles of the disclosed embodiments.

Server 110 may include any appropriate computer system capable of serving other computing devices or computer systems. For example, server 110 may include a workstation, a personal computer, a mainframe computer, or any computing device with one or more central processing unit (CPU). Server 110 may also include more than one computers or processors configured in parallel or in clusters to provide serving functions collectively. Server 110 may implement business process 112 to carry out certain serving functions, such as pricing and revenue measurement and analysis, etc.

Business process 112 may include one or more appropriate computer software programs designed to automatically measure and analyze product pricing and revenue. For example, business process 112 may include an enterprise resource planning (ERP) software, pricing modeling tools and reporting software, and/or any other transaction software programs, etc. Business process 112 may use input data of input 114 to generate output data of output 116.

Supplier 120 and supplier 122 may provide data to server 110 and, more specifically, business process 112. Supplier 120 and supplier 122 may include any appropriate computing devices, such as computer systems, to collect, process, and communicate the data to business process 112. Supplier 120 and supplier 122 may be located in different geographical locations and/or in different branch offices or departments of a business organization. For example, supplier 120 and supplier 122 may be in different states or in different countries; supplier 120 and supplier 122 may be located in separate business entities, such as different brokers and/or dealers; or supplier 120 and supplier 122 may be located in different departments, such as product development department, accounting department, marketing department, operation department, and/or analysis department, etc.

Being located in different locations, supplier 120 and supplier 122 may communicate with business process 112 via network 140. Network 140 may include any appropriate type of communication network, such as a local area network (LAN), a wide area network (WAN), a wireless communication network, or the Internet. The Internet may refer to any network or networks interconnected via communication protocols, such as transmission control protocol/internet protocol (TCP/IP).

Consumer 130 and consumer 132 may use output data generated by server 110 and, more specifically, business process 112. Consumer 130 and consumer 132 may include any appropriate computing devices, such as computer systems, to exchange output data with business process 112. Consumer 130 and consumer 132 may also be located in different geographical locations and/or in different branch offices or departments of the business organization, and may be used by various business users, such as customers, market supporting staff, distributors, and/or service staff, etc. In certain circumstances, consumer 130 and consumer 132 may coincide with supplier 120 and supplier 122. Further, consumer 130 and consumer 132 may also communicate with business process 112 via network 140 such that output 116 may be transmitted to or presented to consumer 130 and consumer 132 remotely by business process 112.

As explained, business process 112 may generate output 116 based on input 114. Input 114 may include any type of data related to pricing and revenue measurement and analysis. For example, input 114 may include financial data, accounting data, order data, shipment data, invoicing data, dealer data, rebating or discount data, price and revenue model data, and/or foreign currency and sales data, etc. Further, server 110 may obtain input 114 from various sources. For example, server 110 may obtain input 114 locally from a database or a data storage device. Server 110 may also obtain input 114 remotely from various data suppliers, e.g., suppliers 120 and 122. Server 110 may send a data request to the data suppliers so that all data suppliers may send input data to server 110 to form input 114.

Output 116, on the other hand, may reflect results of the pricing and revenue measurement and analysis performed by business process 112. Output 116 may include any appropriate form of output data. For example, output 116 may include various reports, such as marketing reports, operation reports, accountable reports, pricing and revenue report, department expense report, warranty report, etc. Output 116 may also include illustrative charts or diagrams, such as price band analysis diagrams, waterfall revenue prediction diagrams, etc. Other forms of output data may also be used.

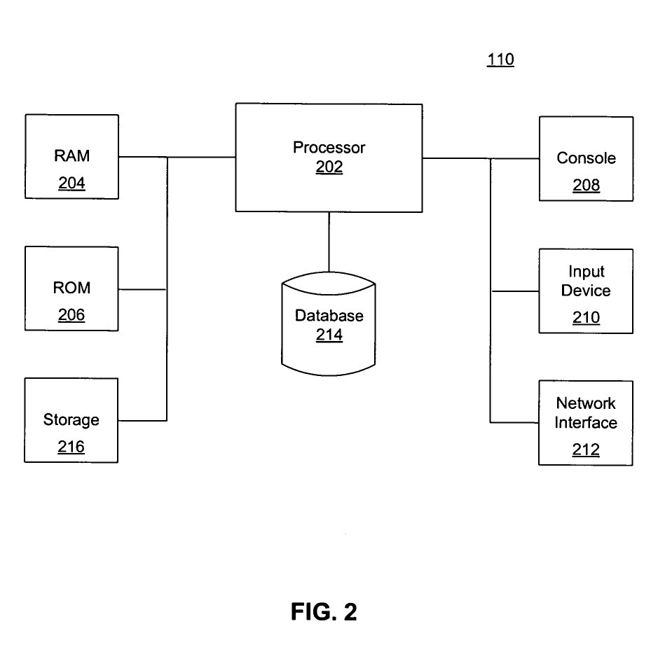

As explained above, business process 112 may be implemented or executed by server 110. FIG. 2 shows a functional block diagram of an exemplary server 110 consistent with certain disclosed embodiments. As shown in FIG. 2, server 110 may include a processor 202, a random access memory (RAM) 204, a read-only memory (ROM) 206, a console 208, an input device 210, a network interface 212, a database 214, and a storage 216. It is understood that the type and number of listed devices are exemplary only and not intended to be limiting. The number of listed devices may be changed and other devices may be added.

Processor 202 may include any appropriate type of general purpose microprocessor, digital signal processor, or microcontroller. Processor 202 may execute sequences of computer program instructions to perform various processes as explained above. Processor 202 may be coupled to or access other devices, such as RAM 204, ROM 206, console 208, input device 210, network interface 212, database 214, and/or storage 216, to complete executions of computer program instructions. The computer program instructions may be loaded into RAM 204 for execution by processor 202 from read-only memory (ROM) 206, or from storage 216. Storage 216 may include any appropriate type of mass storage provided to store any type of information that processor 202 may need to perform the processes. For example, storage 216 may include one or more floppy disk device, hard disk device, optical disk device, memory disk device, or other storage devices to provide storage space.

Console 208 may provide a graphic user interface (GUI) to display information to a user or users of server 110. Console 208 may include any appropriate type of computer display device or computer monitor. Input device 210 may be provided for the user to input information into server 110. Input device 210 may include a keyboard, a mouse, or other optical or wireless computer input device, etc. Further, network interface 212 may provide communication connections such that server 110 may be accessed remotely through computer networks via various communication protocols, such as transmission control protocol/internet protocol (TCP/IP), hyper text transfer protocol (HTTP), etc.

Database 214 may contain any data and/or any information related to pricing and revenue measurement and analysis applications. Database 214 may include any type of commercial or customized database. Database 214 may also include analysis tools for analyzing the information in the database. Processor 202 may also use database 214 to determine and store model data used to establish business process 112.

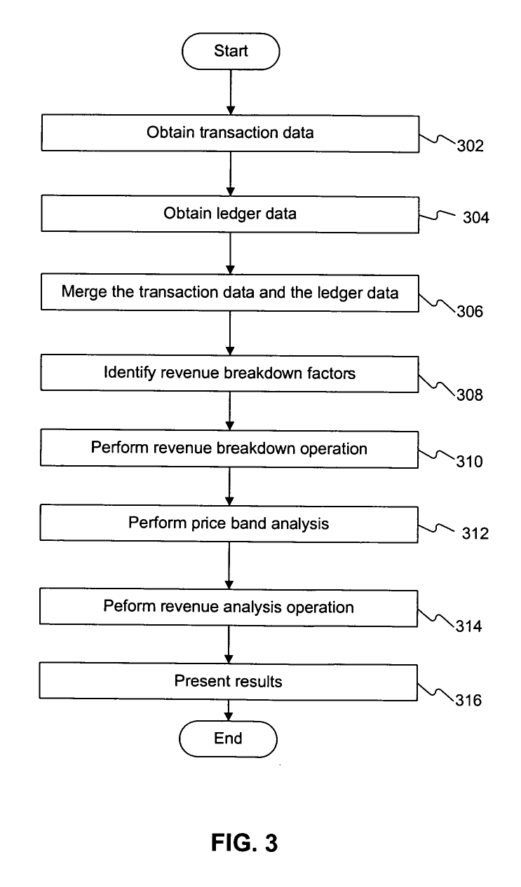

Processor 202 may execute business process 112 and/or other software programs to perform a pricing and revenue forecasting process. FIG. 3 shows an exemplary pricing and revenue forecasting process performed by processor 202.

As shown in FIG. 3, processor 202 may obtain transaction data of a product (step 302). A product may include any type of equipment, such as a machine. Transaction data, as used herein, may refer to any appropriate information associated with transactions of one or more product. For example, transaction data may include shipment information, distributor information, product identification such as serial number, sales information, etc.

Processor 202 may also obtain ledger data of the product (step 304). Ledger data, as used herein, may refer to any appropriate information associated with accounting of sales of the product. For example, ledger data may include any price related information or any information corresponding to financial aspects of the product. Ledger data may also include product related information associated with the financial data, such as serial number, volume of sale, etc.

After obtaining the transaction data and the ledger data, processor 202 may merge the transaction data and the ledger data (step 306). Processor 202 may merge or consolidate the transaction data and the ledger data by creating new data entries including attributes included in both the transaction data and the ledger data. For example, processor 202 may identify a transaction data entry with a serial number of a product and a ledger data entry with the same serial number, and may create a new data entry with the serial number including both the transaction data and the ledger data entry. Optionally, processor 202 may store the new data entries in database 214 for further analysis.

The transaction data and the ledger data may include both historical data and current data. For example, the transaction data may reflect transactions happened in a previous year or a previous accounting period and may also reflect transactions have happened or is happening in a current year or a current accounting period. The ledger data may also reflect price and revenue information in the previous year or the previous accounting period, as well as in the current year or the current accounting period.

From the merged data entries, processor 202 may identify revenue breakdown factors (step 308). A revenue breakdown factor, as used herein, may refer to a financial or transaction variable that quantitatively increases or decreases revenue or price realization of a product. Processor 202 may identify various revenue breakdown factors, such as sales variance, geographical mix, price action, price structure variance (PSV), currency, volume, and/or new product introduction (NPI), etc. Other factors, however, may also be used.

Sales variance may include various discounts given in connection with the sale of a product. The discounts may be different from time to time, and a difference between a current discount and a previous discount may cause a difference in a current revenue and a previous revenue. Geographical mix may reflect price differences because of sales associated with different geographical regions. Different sales regions may have different services, different logistic costs, and/or different warranties, etc., and may result in price or revenue differences. Geographical mix may also be used to indicate revenue production of a geographical region. For example, geographical mix may indicate which region has the highest revenue or which product in which region has the highest price realization, etc.

Price action may refer to a decision or action to increase or decrease the price of the product. The increased or decreased price may therefore reflect differences in revenue generation. Further, price structure variance (PSV) may reflect different price schemes for different regions or different distributors. For example, PSV may indicate a price differences between different geographical regions or between different dealers. Currency may reflect changes in revenue because of changes in currency or changes in currency exchange rate. Volume may reflect revenue production associated with the total amount of sales of the product. Further, new product introduction (NPI) may reflect revenue changes associated with an addition or removal of new or enhanced features. For example, a vehicle with an enhanced engine may produce more revenue than a vehicle without the enhanced engine.

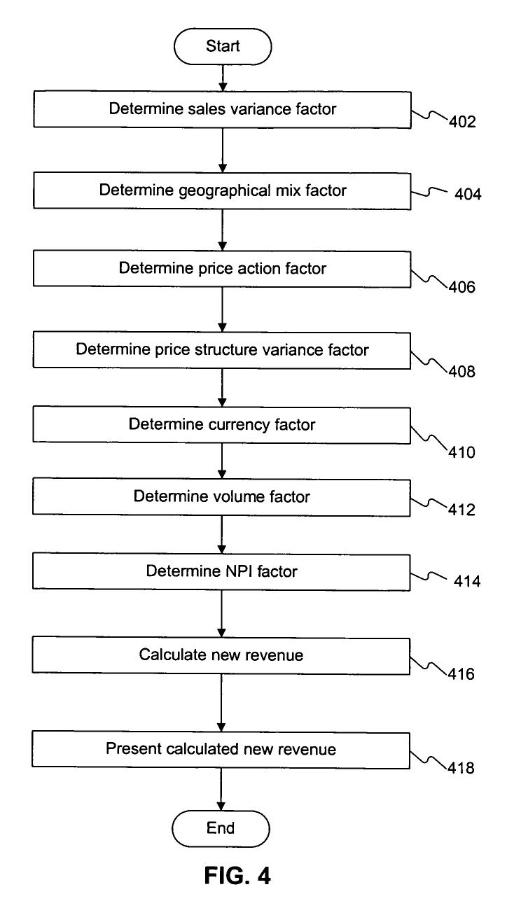

Processor 202 may identify the revenue breakdown factors by any appropriate method. For example, processor 202 may determine the revenue breakdown factors from inputs of the user of server 110. Processor 202 may also determine the revenue breakdown factors by using a simulation algorithm or certain database related tools, such as data mining tools or data warehousing tools, etc. After identifying the revenue breakdown factors (step 308), processor 202 may perform revenue breakdown operation (step 310). The revenue breakdown operation may predict a future or new revenue based on revenue breakdown factors and a previous revenue for a particular product. FIG. 4 shows an exemplary revenue breakdown process performed by processor 202.

As shown in FIG. 4, processor 202 may determine a sales variance factor (step 402). Processor 202 may calculate the sales variance factor as an increase or a decrease in revenue generation associated with sales variance of the product. Processor 202 may also determine a geographical mix factor (step 404). Processor 202 may calculate the geographical mix factor as an increase or a decrease in revenue generation associated with geographical mix of the product. Further, processor 202 may determine a price action factor (step 406). Processor 202 may calculate the price action factor as an increase or a decrease in revenue generation associated with price increasing or decreasing in sales of the product.

Processor 202 may determine a PSV factor (step 408). Processor 202 may calculate the PSV factor as an increase or a decrease in revenue generation associated with price structure variance of the product. Processor 202 may also determine a currency factor (step 410). Processor 202 may calculate the currency factor as an increase or a decrease in revenue generation associated with foreign currency variations. For example, for overseas sales or transactions of the product, processor 202 may determine foreign currency and/or foreign currency exchange rate for the sales of the product.

Processor 202 may also determine a volume factor (step 412). Processor 202 may calculate the volume factor as an increase or a decrease in revenue generation associated with sales volume of the product. Further, processor 202 may determine a new production introduction (NPI) factor (step 414). Processor 202 may calculate the NPI factor as an increase or a decrease in revenue generation associated with an addition or removal of an enhanced feature or a new configuration of features of the product.

After determining the revenue breakdown factors, processor 202 may calculate or predict a new revenue (step 416). Processor 202 may determine predicted increase and/or decrease in revenue based on individual revenue breakdown factors to calculate the new revenue. For example, processor 202 may combine the individual revenue factors and the previous revenue to generate the new predicted revenue.

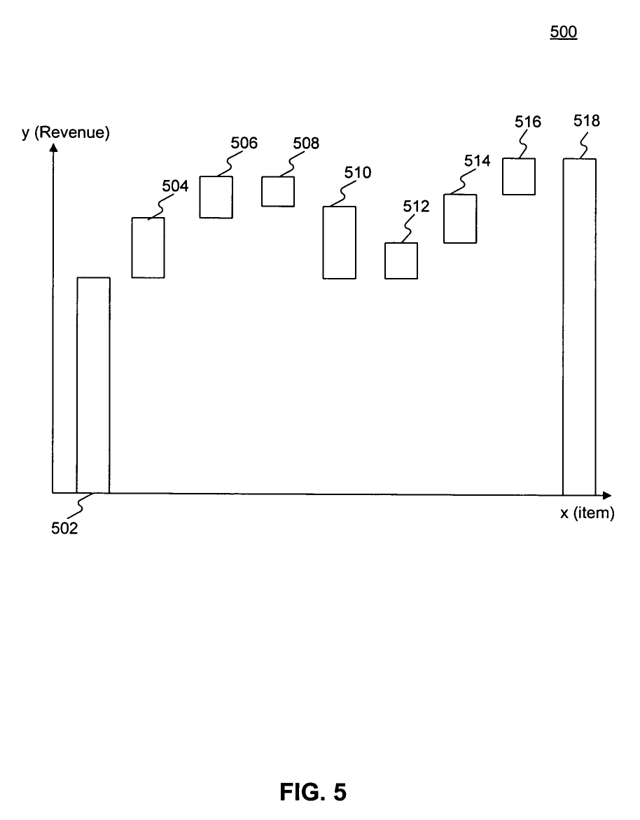

After calculating the predicted new revenue, processor 202 may present the calculated or predicted new revenue (step 418). Processor 202 may present the predicted new revenue to the user of server 110 and/or to other computer programs. Processor 202 may also present the predicted new revenue as output 116 to various computer systems, such as consumer 130 and consumer 132, etc. Further, processor 202 may present the predicted new revenue in various formats. For example, processor 202 may present the predicted new revenue as a waterfall or bucket diagram. FIG. 5 shows an exemplary waterfall diagram of predicted new revenue.

As shown in FIG. 5, waterfall diagram 500 may include a previous revenue 502, a price action factor 504, an NPI factor 506, a PSV factor 508, a sales variance 510, a geographical mix 512, a currency factor 514, a volume factor 516, and a new revenue 518. Other factors, however, may also be included. Further, the X-axis may represent items such as revenues and factors, and the Y-axis may represent an amount of revenue or revenue equivalent. As explained above, each factor may have an increasing or decreasing effect on the new revenue. Predicted new revenue 518 may be a combination of previous revenue 502, price action factor 504, NPI factor 506, PSV factor 508, sales variance 510, geographical mix 512, currency factor 514, and volume factor 516.

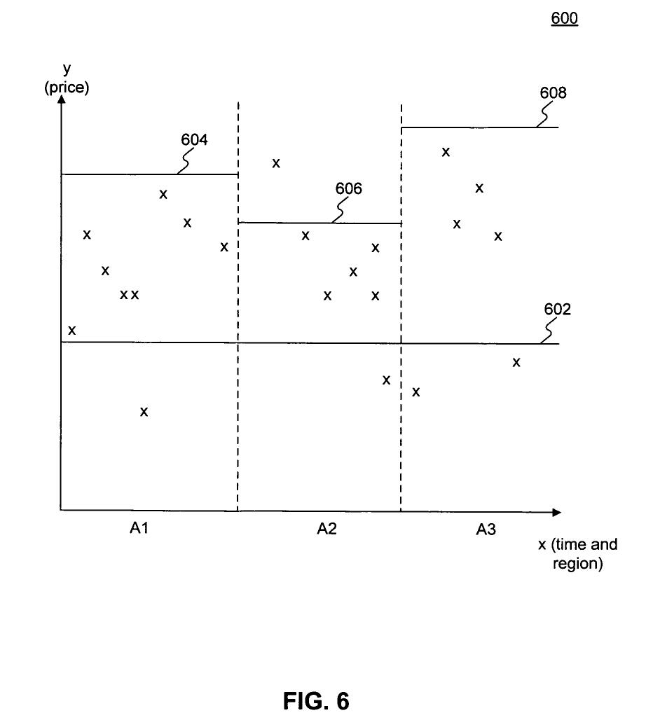

Returning to FIG. 3, after performing revenue breakdown operation (step 310), processor 202 may perform price band analysis (step 312). Price band analysis may refer to analysis and monitoring of sales prices of a product. Processor 202 may process the merged data, the revenue breakdown factors, and/or the predicted new revenue to determine a price band for monitor existing prices of a product and for determining future prices for the product. For example, processor 202 may generate a price band diagram and monitor the existing prices and/or determine future prices based on the price band diagram. A price band diagram, as used herein, may refer to any appropriate diagram or chart indicating one or more price range of a product. FIG. 6 shows an exemplary price band diagram.

As shown in FIG. 6, price band diagram 600 may include a floor price 602, a ceiling price 604 associated with sales region A1, a ceiling price 606 associated with sales region A2, and a ceiling price 608 associated with sales region A3. The number of ceiling prices, floor price, and sales region are exemplary only and not intended to be limiting. Any number of ceiling prices, floor prices, and sales regions may be included in price band diagram 600. Further, the X-axis may represent time of sale in a corresponding region, and the Y-axis may represent price in a monetary term. A mark “x” may represent a particular sale the product, such as a previous sale, a current sale, or a future sale.

When establishing price band diagram 600, processor 202 may determine a floor price that, after considering all revenue breakdown factors, may generate a new revenue that meets a minimum revenue requirement. On the other hand, processor 202 may determine a ceiling price with maximum revenue realization based on the revenue breakdown factors. Alternatively, processor 202 may also use statistical tools to determine the floor price and/or ceiling price based on historical data.

Processor 202 may monitor prices of the product based on price band diagram 600. For example, if a sale price of the product in a specific region is close to or beyond the price band defined by the floor price and the ceiling price, processor 202 may generate a warning message to indicate that the price may need to be reconsidered.

On the other hand, processor 202 may choose a future price for the product within the price band. For example, processor 202 may choose a price in the middle of the price band or may choose a price based on priorities of the revenue breakdown factors. Processor 202 may first choose values of one or more breakdown factors with higher priorities and may determine a future price within the price band and may further determine other remaining revenue breakdown factors according to the future price.

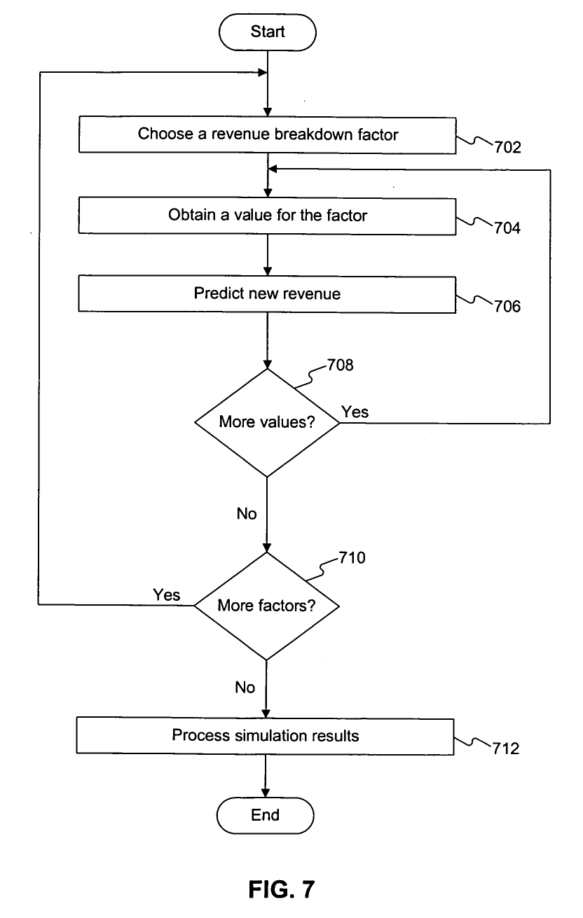

After performing price band analysis (step 312), processor 202 may perform revenue analysis operation (step 314). For example, processor 202 may choose different values for the revenue breakdown factors and predict corresponding revenues. From the new predicted revenues, processor 202 may determine a desired set of values of revenue breakdown factors for making business decisions. FIG. 7 shows an exemplary revenue analysis process consistent with certain disclosed embodiments.

As shown in FIG. 7, processor 202 may choose a revenue breakdown factor for simulation or analysis (step 702). Processor 202 may choose the revenue breakdown factor according to an input from the user of server 110 or from a predetermined sequence of factors. For example, processor 202 may choose a revenue breakdown factor from certain revenue breakdown factors, such as price action factor 504, NPI factor 506, PSV factor 508, sales variance 510, geographical mix 512, currency factor 514, and volume factor 516, etc.

After choosing the revenue breakdown factor (step 702), processor 202 may obtain a value for the chosen revenue breakdown factor (step 704). Processor 202 may obtain the value via a user input, from database 214, and/or from any appropriate software program. Further, processor 202 may predict a new revenue based on the value of the chosen revenue breakdown factor (step 706). Processor 202 may predict the new revenue as described in step 310 of FIG. 3 based on the values of the revenue breakdown factors. That is, processor 202 may simulate the new revenue with the chosen revenue breakdown factor as a variable. Other prediction methods, however, may also be used.

Further, processor 202 may determine whether more values for the chosen revenue breakdown factor are available (step 708). If more values are available (step 708; yes), processor 202 may continue the analysis process in step 704. On the other hand, if no more values are available (step 708; no), processor 202 may further determine whether more revenue breakdown factors need to be considered (step 710).

If more revenue breakdown factors need to be considered (step 710; yes), processor 202 may continue the analysis process in step 702. On the other hand, if no more revenue breakdown factors need to be considered (step 710; no), processor 202 may process results of the simulation (step 712). For example, processor 202 may determine one or more revenue breakdown factor bringing the most revenue, one or more product generating the highest revenue, and/or a most desirable region for creating the highest revenue, etc. Processor 202 may also present the results to the user of server 110 or to consumers 130 and 132 to make desirable business decisions.

Returning to FIG. 3, after performing revenue analysis operation (step 314), processor 202 may present results of the pricing and revenue measurement and analysis process (step 316). For example, processor 202 may generate various reports to include results of the pricing measurement and analysis process. Processor 202 may generate various reports, such as marketing reports, operation reports, accounting reports, pricing and revenue reports, department expense reports, warranty reports, etc., to be included in output 116. Processor 202 may also exchange these reports with various business entities, such as consumer 130 and consumer 132, etc.

### INDUSTRIAL APPLICABILITY

The disclosed systems and methods may provide efficient and effective solutions to enterprise-wide revenue data analysis by using a central management and common tool for data collection, data analysis, and decision making. The central management and common tool may be used globally for a large business organization to improve processes for forecasting business measurements, especially on worldwide machine pricing forecasting and analysis.

The disclosed systems and methods may also be used to provide a global system to provide one safe source for pricing information and provide an ability to model future information used in various business decision processes. Abilities for generating graphical illustrations for price information involved, such as price realization, relationships with other business factors, and price bands, etc., may also be provided. The disclosed systems and methods may enable business users to perform annual analysis of pricing data or monthly analysis of pricing data, and may provide the users with various business reports for different aspects of the pricing information, such as price realization charts, sales variance tracking, model price monitoring, and/or measurement of confidence of data, etc.

The disclosed systems and methods may also be integrated into other business software programs to provide financial analysis functionalities and, more particularly, pricing and revenue analysis functionalities. Further, the disclosed systems and methods may also be used in non-financial analysis.

Other embodiments, features, aspects, and principles of the disclosed exemplary systems will be apparent to those skilled in the art and may be implemented in various environments and systems.

What is claimed is:

1. A method for analyzing pricing and revenue information of a product of a business organization having a plurality of data suppliers, comprising:
obtaining transaction data associated with the product;
obtaining ledger data associated with the product;
merging the transaction data and the ledger data to generate new data entries;
identifying a plurality of revenue breakdown factors corresponding to revenue of the product based on the new data entries; and
predicting a new revenue based on the plurality of revenue breakdown factors and a previous revenue from the ledger data.

2. The method according to claim 1, further including:
generating a revenue waterfall diagram based on the new revenue, the plurality of revenue breakdown factors, and the previous revenue.

3. The method according to claim 1, further including:
generating a price band diagram to monitor existing prices of the product.

4. The method according to claim 3, further including:
determining future prices of the product based on the price band diagram.

5. The method according to claim 1, further including:
simulating the new revenue with different values of the plurality of revenue breakdown factors; and
determining a revenue breakdown factor generating a highest revenue.

6. The method according to claim 1, wherein the plurality of revenue breakdown factors include a sales variance factor.

7. The method according to claim 1, wherein the plurality of revenue breakdown factors include a geographic mix factor.

8. The method according to claim 1, wherein the plurality of revenue breakdown factors include a price action factor.

9. The method according to claim 1, wherein the plurality of revenue breakdown factors include a price structure variance factor.

10. The method according to claim 1, wherein the plurality of revenue breakdown factors include a currency factor.

11. The method according to claim 1, wherein the plurality of revenue breakdown factors include a volume factor.

12. The method according to claim 1, wherein the plurality of revenue breakdown factors include a new product introduction factor.

13. The method according to claim 3, wherein the price band diagram includes:
a floor price for the product;
a plurality of ceiling prices of the product corresponding to a plurality of sales regions of the product.

14. The method according to claim 1, wherein the transaction data and the ledger data are obtained from different data suppliers from the plurality of data suppliers.

15. The method according to claim 14, further including:
generating a plurality of reports for different data consumers in different departments of the business organization.

16. A computer system, comprising:
a processor configured to:
obtain transaction data associated with a product of a business organization having a plurality of data suppliers,
obtain ledger data associated with the product,
merge the transaction data and the ledger data to generate new data entries,
identify a plurality of revenue breakdown factors corresponding to revenue of the product based on the new data entries, and
predict a new revenue based on the plurality of revenue breakdown factors and a previous revenue from the ledger data; and
a database configured to store the transaction data, the ledger data, and the new data entries.

17. The computer system according to claim 16, wherein the processor is further configured to:
generate a revenue waterfall diagram based on the new revenue, the plurality of revenue breakdown factors, and the previous revenue; and
generate a plurality of reports for different data consumers in different departments of the business organization.

18. The computer system according to claim 16, wherein the processor is further configured to:
generate a price band diagram to monitor existing prices of the product, wherein the price band diagram includes a floor price for the product and a plurality of ceiling prices of the product corresponding to a plurality of sales regions of the product; and
determine future prices of the product based on the price band diagram.

19. The computer system according to claim 16, wherein the processor is further configured to:
simulate the new revenue with different values of the plurality of revenue breakdown factors; and
determine a revenue breakdown factor generating a highest revenue.

20. The computer system according to claim 16, wherein the plurality of revenue breakdown factors include one or more of a sales variance factor; a geographic mix factor; a price action factor; a price structure variance factor; a currency factor; a volume factor; and a new product introduction factor.
